(19) United States
(12) Patent Application Publication
(10) Pub. No.: US 2025/0220665 A1
(43) Pub. Date: Jul. 3, 2025

(54) SYSTEMS AND METHODS FOR IMPROVING THROUGHPUT AND LATENCY AT BASE STATIONS AND USER EQUIPMENT DEVICES

(71) Applicant: Verizon Patent and Licensing Inc., Basking Ridge, NJ (US)

(72) Inventors: Yong Sang Cho, Old Tappan, NJ (US); Lily Zhu, Parsippany, NJ (US); Jeremy Nacer, Boca Raton, FL (US)

(21) Appl. No.: 18/398,439

(22) Filed: Dec. 28, 2023

(51) Int. Cl. H04W 72/1268; H04W 72/52; H04W 72/542

(52) U.S. Cl. CPC H04W 72/1268; H04W 72/52; H04W 72/542

(57) ABSTRACT

A device may include a processor. The processor may be configured to: receive, from one or more network components, key performance indicators (KPIs) and parameters that are associated with a User Equipment device; select a scheduling strategy, for data communications over a wireless link between the device and the UE, based on the KPIs and the parameters; apply the selected scheduling strategy to schedule data for transmission to the UE; and transmit the data to the UE based on the scheduling.

### BACKGROUND INFORMATION

Deployment of advanced cellular networks poses optimization challenges for mobile network operators as more technologically advanced User Equipment devices (UE) make their way into the marketplace. UEs typically exhibit complex transmission and reception behavior that depends on the settings of base stations in the Radio Access Networks (RANs). Identifying different settings that may be adjusted at the base stations to improve wireless communications with the UEs, however, can be difficult, as the base stations employ a wide range of technologies.

### BRIEF DESCRIPTION OF THE DRAWINGS

FIGS. 1A and 1B illustrate concepts described herein.

FIG. 2 illustrates an exemplary network environment in which systems and methods described herein may be implemented.

FIG. 3 depicts example functional components of a system for improving cell throughput and latency, according to an implementation.

FIG. 4 is a flow diagram of an example process performed by an access station for improving cell latency, according to an implementation.

FIG. 5 is a flow diagram of an example process performed by an access station for improving cell latency, according to another implementation.

FIG. 6 is a flow diagram of an example process performed by an access station for improving cell throughput, according to an implementation.

FIG. 7 depicts exemplary functional components of a network device according to an implementation.

### DETAILED DESCRIPTION

The following detailed description refers to the accompanying drawings. The same reference numbers in different drawings may identify the same or similar elements.

As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID).

As used herein, the term “session” may refer to a series of communications, of a limited duration, between two endpoints (e.g., two applications). When a session is established between an application and a network or a network slice, the session is established between the application and another application/server hosted by the network or the network slice. Similarly, if a session is established between a device and a network slice or a network, the session is established between an application on the device and another application on either the network slice or the network.

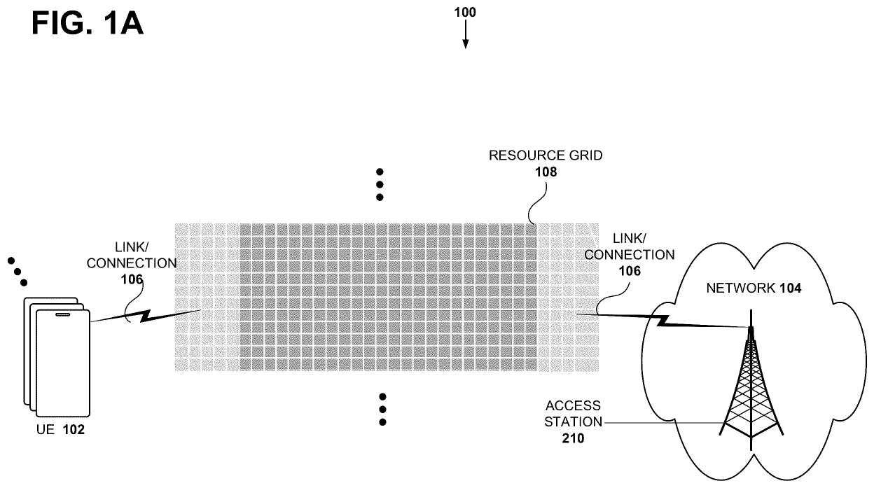

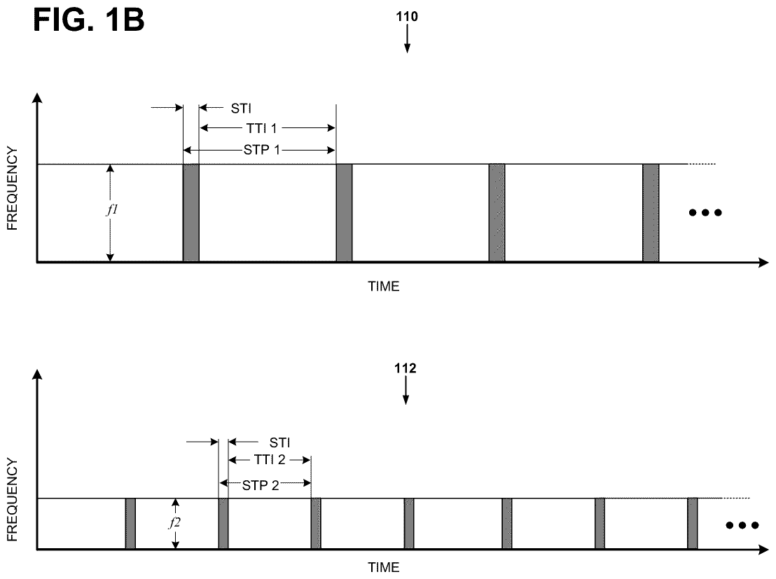

Systems and methods described herein relate to improving at least two performance parameters, such as latency and throughput at base stations in Radio Access Networks (RANs). FIGS. 1A-1D illustrate concepts described herein. Referring to FIG. 1A, in environment 100, one or more UEs 102 (collectively referred to as UEs 102 and generically as UE 102 (e.g., a smart phone) may establish a radio frequency (RF) communication link 106 with an access station 210 (e.g., a base station) in a provider network 104. UE 102 and access station 210 may exchange data in the form of symbols (e.g., Orthogonal Frequency Division Multiplexing (OFDM) symbols) over link 106, which may include a range of frequencies and time ranges. In FIG. 1A, the frequencies (illustrated as extending vertically) and the time ranges (illustrated as extending horizontally) form a radio resource grid 108. Radio resource grid 108 may include physical resource blocks (PRBs), shown as squares. Each resource block in turn may include resource elements. When access station 210 is scheduling data for downlink transmission or uplink reception, access station 210 may identify radio resources (PRBs or resource elements) that the data will occupy and may assign the identified radio resources to the data. Access station 210 may transmit or receive the scheduled data in accordance with the assigned radio resources.

For network 104 hosting access station 210 to render low latency services to applications that run on UE 102, the scheduler in access station 210 needs to provide consistent scheduling priorities for higher Quality-of-Service (QOS) traffic even when the RAN in network 104 is congested. Under loaded network conditions, however, it is difficult for network 104 to guarantee and maintain low latencies for higher QoS traffic. In some instances, the scheduler plays the biggest role in overall latency.

The throughput at access station 210 is impacted by rank K at the Multiple-Input Multiple-Output (MIMO) antenna system across access station 210 and UE 102. As used herein, the term “rank” may refer to the dimension of the transmission matrix that relates an X number of MIMO transmitters at access station 210 to an R number of receivers at UE 102. In practice, access station 210 may determine the transmission channel rank K partly based on UE 102's estimation of the rank (K_{UE}) and the number of receivers Y that UE 102 decides to use for link 106. That is, when UE 102 determines the values of K_{UE} and Y and sends the values to access station 210, access station 210 may use the received values of K_{UE} and Y to set the rank K. Consequently, access station 210 may set suboptimal K value for its MIMO should UE 102 provide inaccurate K_{UE} and/or Y values.

For example, in UE 102, the logic for determining K_{UE} and Y in UE 102 depends on the particular vendor implementation of the chipset and firmware/software in the UE communication system. If the chipset in UE 102 caps the values of K_{UE} and/or Y for a particular reason (e.g., conserve UE battery power), access station 210 may set K to a suboptimal value that leads to degradation of the channel throughput. Accordingly, for the scheduler in access station 210 to consistently achieve desired levels of throughput, the scheduler needs to prevent UE 102 from unnecessarily limiting the values of K_{UE} and Y and, if possible, steer UE 102 to maintain higher values of K_{UE} and Y (e.g., K_{UE}≥2 and/or Y≥2).

FIG. 1B shows example activities for the scheduler over time under different access station settings 110 and 112. Settings 110 and 112 correspond to, respectively, scheduling strategy S₁ and S₂. Under setting 110 (scheduling strategy S₁), access station 210 is configured to transmit to (or receive from) UE 102 in accordance with a scheduling time period (STP), where the period is equal to the sum of a scheduling time interval (STI) and a transmission time interval (TTI) (e.g., STP=STI+TTI). During each STI, the scheduler in access station 210 may schedule data to be transmitted or received; and during each TTI, access station 210 may transmit to or receive from UE 102 the scheduled data. The transmission or reception may occupy a frequency band f. Under setting 110 (scheduling strategy S₁), the f and STP are shown as f1 and STP 1; and under setting 112 (scheduling strategy S₂), f and STP are shown as f2 and STP 2, where STP 1>STP 2 and f1>f2. The STI is the same for both settings 110 and 112 of access station 210.

Systems described herein include schedulers that adjust the values of STP and f (i.e., adjust its scheduling strategy S) for UEs 102 to improve cell latency and throughput under various network loading conditions. For example, when network 104 is under a light load, a system may select a scheduling g strategy S with large values of f and STP (e.g., scheduling strategy S₁). Because each UE 102 is assigned a large frequency band f, the scheduler may assign, for the UE 102, more PRBs available for scheduling data and thus permit the UE 102 to enjoy greater communication bandwidths.

In contrast, when network 104 is under a heavy load, the system may select a scheduling strategy with smaller values of f and STP (e.g., scheduling strategy S₂). Because each UE 102 is assigned a smaller frequency band f, the system may assign more UEs 102 per cell band, lessening its need to multiplex scheduling UEs 102 whose band f may overlap. This in turn may lead to lower latency and increased throughput during network congestion. The system may select the scheduling strategy based on particular Key Performance Indicators (KPIs), such as a cell throughput, a cell latency, a PRB utilization rate of the cell, and a UE throughput at the cell, and parameters related to the UE 102, such as a Reference Signal Received Power (RSRP), a Signal to Interference Plus Noise Ratio (SINR), a Channel Quality Information (CQI), a rank indicator (RI), an identifier of a network slice associated with the UE 102, a price plan associated with the UE 102, a Quality-of-Service identifier associated with the UE 102, application running on the UE 102, a standard UE category for the UE 102, an operator-defined UE category for the UE 102, a UE group to which the UE 102 belongs (e.g., based on UE signal quality), a make and model of UE 102, the processor type, the amount of memory, the OS of the UE 102, etc.

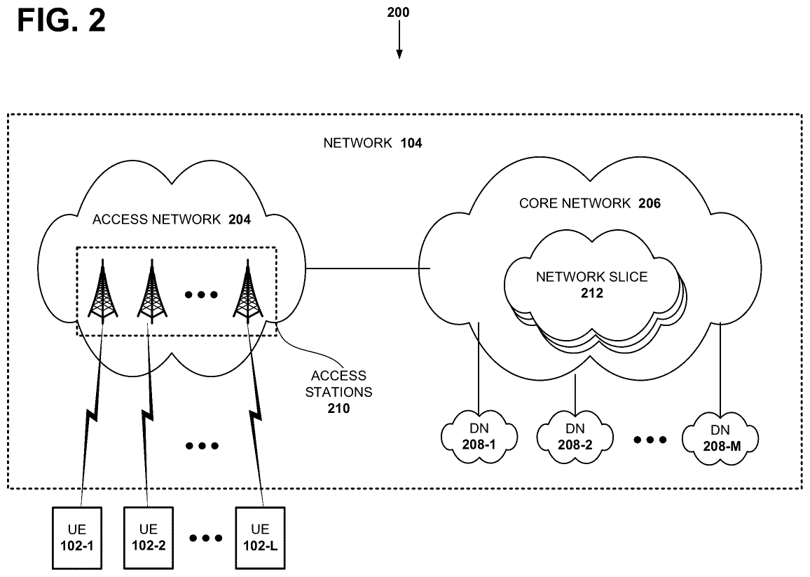

FIG. 2 illustrates an exemplary network environment 200 in which the systems and methods described herein may be implemented. As shown, network environment 200 may include UEs 102-1 through 102-L (collectively referred to as UEs 102 and generically referred to as UE 102), access network 204, core network 206, and data networks (DNS) 208-1 through 208-M (collectively referred to as data networks 208 and generically as data network 208). Access network 204, core network 206, and data networks 208 may be part of cellular network 104.

UEs 102 may include a wireless communication devices capable of Fourth Generation (4G) (e.g., Long-Term Evolution (LTE)) communication and/or Fifth Generation (5G) New Radio (NR) communication. Examples of UE 102 include: a Fixed Wireless Access (FWA) device; a Customer Premises Equipment (CPE) device with 4G and 5G capabilities; a smart phone; a tablet device; a wearable computer device (e.g., a smart watch); a global positioning system (GPS) device; a laptop computer; a media playing device; a portable gaming system; an autonomous vehicle navigation system; a sensor; and an Internet-of-Things (IoT) device. In some implementations, UE 102 may include a wireless Machine-Type-Communication (MTC) device that communicates with other devices over a machine-to-machine (M2M) interface, such as LTE-M or Category M1 (CAT-M1) devices and Narrow Band (NB)-IoT devices. UEs 102 may be capable of using MIMO communication with access stations 210 in network 104. In some implementations, UE 102 may be assigned to a UE group by network 104 based on various criteria (e.g., a UE signal quality) or to one of UE categories. The UE categories may be standard UE categories (e.g., UE categories defined by Third Generation Partnership Project (EGPP) or by the network operator/network 104).

Access network 204 may allow UE 102 to access core network 206. To do so, access network 204 may establish and maintain, with participation from UE 102, an over-the-air channel with UEs 102; and maintain backhaul channels with core network 206. Access network 204 may relay information through such channels, from UEs 102 to core network 206 and vice versa. Access network 204 may include an LTE radio access network and/or a 5G NR access network, or another advanced radio access network. These networks may include many central units (CUs), distributed units (DUs), radio units (RUs), and wireless stations (e.g., base stations), some of which are illustrated in FIG. 2 as access stations 210 for establishing and maintaining over-the-air channels with UEs 102. In some implementations, access station 210 may include a 4G, 5G, or another type of base station that includes one or more radio frequency (RF) transceivers. In some implementations, access station 210 may be part of an evolved Universal Mobile Telecommunications Service (UMTS) Terrestrial Radio Access Network (eUTRAN). One or more access stations 210 may include schedulers capable of setting f, STP, STI, and/or TTI, thus capable of operating under settings similar to setting 110, setting 112, or another setting.

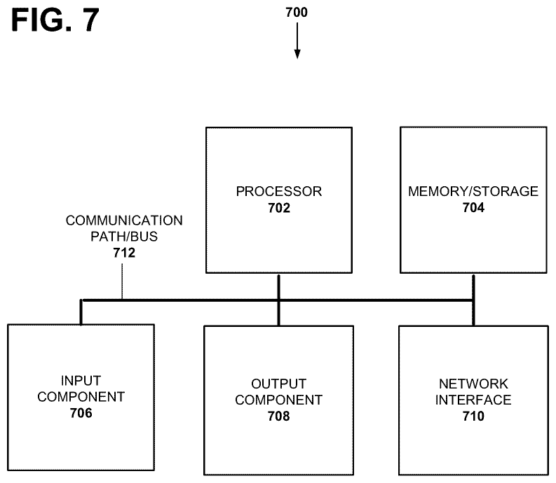

Core network 206 may manage communication sessions of subscribers connecting to core network 206 via access network 204. For example, core network 206 may establish an Internet Protocol (IP) connection between UEs 102 and data networks 204. The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a virtual network function (VNF) virtual machine, a Cloud Native Function (CNF) container, an event driven serverless architecture interface, and/or another type of SDN component. The common shared physical infrastructure may be implemented using one or more devices 700 described below with reference to FIG. 7 in a cloud computing center associated with core network 206.

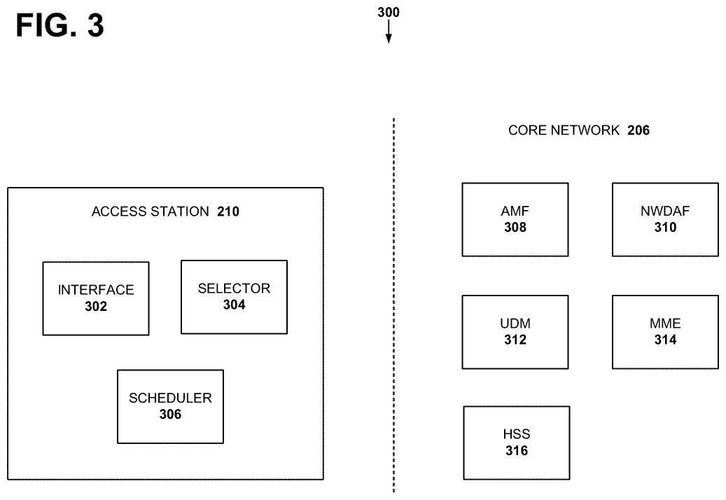

Core network 206 may include 5G core network components, 4G core network components, and/or another type of core network components. These components may be part of or may support the system for improving throughput and latency at access stations 210 and UEs 102. Some of these components are described in greater detail with reference to FIG. 3.

As further shown, core network 206 may include one or more network slices 212. Depending on the embodiment, network slices 212 may be implemented within other networks, such as access network 204 and/or data network 208. Access network 204, core network 206, and data networks 208 may include multiple instances of network slices 212 (collectively referred to as network slices 212). Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport, Central Processing Unit (CPU) cycles, memory, etc. Furthermore, each network slice 212 may be configured to meet a different set of requirements and may be associated with a particular QoS Class Identifier (QCI), a type of service, 5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIOT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice 212 may be associated with corresponding data, stored in core network 206 for example, which includes the S-NSSAI that identifies the network slice 212.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may render services to other applications running on UEs 102 and may establish communication sessions with UEs 102 via core network 206.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3 depicts example functional components of a system 300 for improving cell throughput and latency, according to an implementation. As shown, system 300 may include access station 210 and components of core network 206. Access station 210 may include a parameter interface 302 (interface 302), a scheduling strategy selector 304 (selector 304), and a scheduler 306. Core network 206 may include 5G core network components, such as Access and Mobility Management Function (AMF) 308, a Network Data Analytics Function (NWDAF) 310, and a Unified Data Management 312 (UDM), and/or 4G core network components, such as a Mobility Management Entity (MME) 314 and a Home Subscriber Server (HSS) 316. Depending on the implementation, system 300 may include additional, fewer, or different components than those illustrated in FIG. 3. For example, in one embodiment, system 300 may include other 5G core network components, such as a Session Management Function (SMF), a Network Exposure Function (NEF), etc.

Interface 302 may include mechanisms for obtaining particular Key Performance Indicator (KPI) values that selector 304 may use to determine a load at a cell associated with access station 210. The KPI values may include, for example, a cell throughput, a cell latency, a PRB utilization rate of the cell, and a UE throughput at the cell. In addition, interface 302 may obtain UE-related parameter values, such as QoS identifiers (e.g., 5QI or QCI) for each UE 102, the price plans for the subscriptions associated with the UEs 102, the IDs of network slices 212 to which the UEs 102 are subscribed, UE categories (e.g., one of network operator-defined categories or 3GPP defined categories), a RSRP, a SINR, a CQI, a RI, a UE group (e.g., determined based on a UE signal), a make and model of UE 102, the processor type for UE 102, the amount of memory of UE 102, the OS of the UE 102, applications installed and running on UE 102, etc. Interface 302 may provide the obtained KPIs and parameter values to selector 304. Interface 302 may obtain the KPI values and the parameter values from various sources. For example, interface 302 may obtain the KPI values and UE-specific parameter values from the host access station 210, AMF 308, NWDAF 310, UDM 312, MME 314, and/or HSS 316.

Selector 304 may use the values of the KPIs and parameters provided by interface 302 to select scheduling strategies for UEs 102. Each scheduling strategy may specify values of frequency band f and STP for UE 102 that is wirelessly attached to access station 210 via communication link 106. Selector 304 may provide the selected strategy to scheduler 306 to improve cell throughput and/or latency while maintaining the spectral efficiency of the cell.

According to one embodiment, selector 304 may improve cell latency. For example, selector 304 may be configured to estimate a cell load L that can range from 0 to L_{MAX} (i.e., [0, L_{MAX}]). In addition, selector 304 may be configured to partition the load range [0, L_{MAX}] into subranges [0, T₁], [T₁, T₂] . . . [T_{K-2}, T_{K-1}], and [T_{K-1}, T_{K}]. Furthermore, each of the subranges [T_{N-1}, T_{N}] (where N=1 . . . . K) is associated with a particular scheduling strategy S_{N} that specifies values for frequency band f and STP. In effect, each S_{N} (N>0) may denote a resource partition in frequency, in time, or both in frequency and time. The partitions are such that given two subranges of load [Tᵢ₋₁, T₁] and [Tⱼ₋₁, Tⱼ], if i>j, then fᵢ<fⱼ. and STPᵢ<STPⱼ. A particular band f may occupy a percentage of the cell band per unit time.

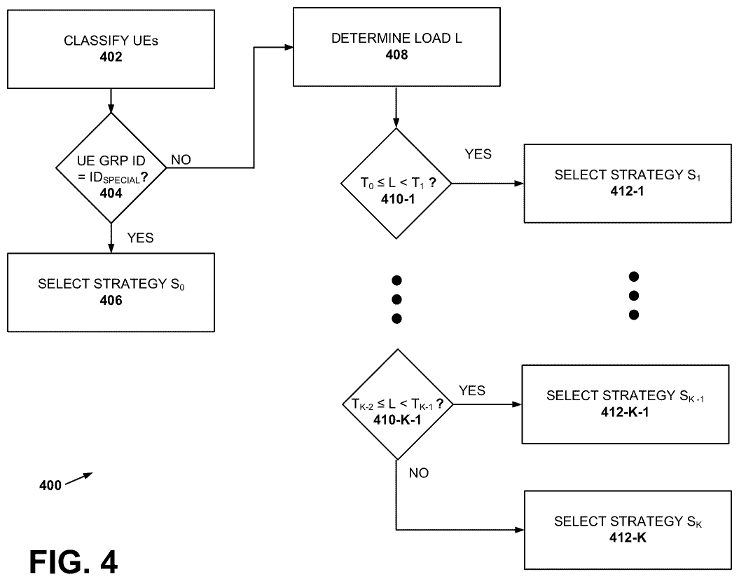

According to an exemplary embodiment, selector 304 may perform a process for selecting scheduling strategies S_{N} (N=0, 1 . . . or K) for the UEs 102 to improve cell latency. FIG. 4 is a flow diagram of an example process 400 performed by selector 304 in access station 210 to reduce cell latency. As shown, process 400 may include selector 304 classifying the UEs 102 in the cell into UE groups (block 402). The classifying may include assigning a UE Group ID that uniquely identifies the UE group to each of the UEs 102 based on the UE-specific parameter values provided via interface 302. The parameter values used for the classification may include, for example, QoS ID (e.g., 5QI or QCI), a price plan of the subscription associated with the UE 102, and/or a network slice ID (e.g., S-NSSAI).

After classifying the UEs 102, selector 304 may determine, for each of the UEs 102, whether the UE group to which UE 102 belongs requires a special scheduling treatment (e.g., determine whether UE group ID=ID_{SPECIAL}) (block 404). If the UE 102 belongs to such a UE group (block 404: YES), selector 304 may select and assign scheduling strategy S₀ (a special strategy with large values of f and STP) for the UE 102 (block 406). On the other hand, if the UE 102 does not belong to a UE group that requires special scheduling treatment (e.g., UE group ID is not equal to ID_{SPECIAL}) (block 404: NO), selector 304 may determine the value of the cell load L (block 408). Selector 304 may determine the value of L based on the KPIs provided by the interface 302. KPIs that selector 304 may use for determining load L may include, for example, the TTI utilization rate, the PRB utilization rate, the cell throughput, and the UE throughput.

Process 400 may further include selector 304 determining into which of the load subranges [T_{N-1}, T_{N}] (N=1 . . . . K) L falls (blocks 410-1 through 410-K−1). If L falls in the subrange [T_{N-1}, T_{N}] (i.e., T_{N-1}≤L<T_{N}] (block 410-N: YES), selector 304 may select scheduling strategy S_{N} associated with the subrange (blocks 412-1 through 412-K−1). If L does not fall in the subrange [T_{N-1}, T_{N}] (block 410-N: NO), selector 304 may proceed to block 410-N+1 to determine if L falls in the next subrange [T_{N-1}, T_{N}]. At block 410-K−1, if L does not fall in the corresponding subrange [T_{K-2}, T_{K-1}] (block 410-K−1: NO), L must fall in the last subrange (since there is only one more possible subrange) and accordingly, selector 304 may select S_{K} as the scheduling strategy (block 412-K).

After selecting S_{N}, selector 304 may provide S_{N} or the values of f and STP for the S_{N} to scheduler 306. In response, scheduler 306 may schedule data to/from UE 102 in accordance with the values of f and STP to reduce cell latency. If the value of L changes while UEs 102 are engaged in sessions, selector 304 may reassign new strategy S for each of the UEs 102 and provide the corresponding values of f and STP to scheduler 306. Because selector 304 may switch to a scheduling strategy whose values of f and STP are smaller when L increases, scheduler 306 may be able to accommodate more UEs 102 at acceptable latencies when the cell is heavily loaded or congested.

In another embodiment, selector 304 may improve cell latency based on UE group IDs. In this embodiment, selector 304 may assign each of the UE group IDs, herein denoted GN (N=0 . . . . K) to a particular scheduling strategy S_{N}. In effect, each S_{N} (N>0) may denote a partition in frequency, in time, or in both frequency and time.

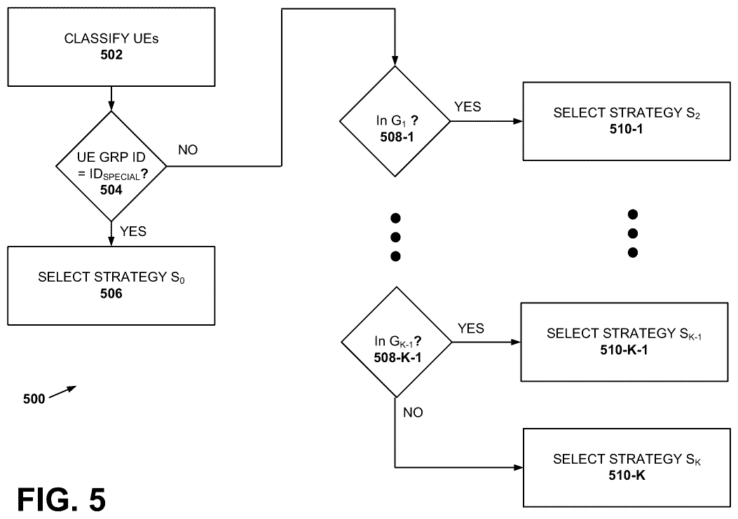

According to this embodiment, selector 304 may perform another process for selecting a particular scheduling strategies S_{N} (N=0, 1 . . . or K) for the UEs 102 based on UE group IDs. FIG. 5 is a flow diagram of another example process 500 performed by selector 304 in access station 210 for improving cell latency based on UE group IDs. As shown, process 500 may include selector 304 classifying UEs 102 in the cell into UE groups (block 502). As in process 400, the classifying may include assigning a UE group ID to each of the UEs 102 based on particular KPIs and the parameter values. The KPIs may include a cell latency, a cell throughput, a cell PRB utilization rate, a cell TTI utilization rate, etc. The parameter values used for the classification may include, for example, QOS ID (e.g., 5QI or QCI), a price plan of the subscription associated with the UE 102, a SINR, a RSRP, a CQI, an RI, a network slice ID (e.g., S-NSSAI), a make and model of UE 102, the processor type, the amount of memory, the OS of the UE 102, applications installed and running on UE 102, etc.

After classifying the UEs 102, selector 304 may determine, for each of the UEs 102, whether the UE 102 belongs to a UE group that requires special scheduling treatment (block 504). If the UE 102 belongs to a UE group that requires special treatment (e.g., UE group ID=ID_{SPECIAL}) (block 504: YES), selector 304 may select and assign scheduling strategy S₀ (a strategy with a relatively large value of f and STP) to the UE 102 (block 506). On the other hand, if the UE 102 does not belong to a UE group that requires special scheduling treatment (e.g., UE group ID is not equal to ID_{SPECIAL}) (block 504: NO), selector 304 may determine to which of the UE groups GN (N=1 . . . . K) the UE 102 belongs (blocks 508-1 through 508-K−1).

At blocks 508-N (N=2 . . . . K−1), if the UE 102 belongs to a particular group GN (the UE group ID of the UE 102 matches the UE group ID of GN) (block 508-N: YES), selector 304 may select strategy S_{N} associated with group GN (block 510-N). On the other hand, if the UE 102 does not belong to GN (the UE group ID of the UE 102 does not match the UE group ID of GN) (block 508-N: NO), selector 304 may proceed to block 508-N+1 to determine if the UE 102 belongs to the next UE group GN+1. At block 508-K−1, if the UE 102 does not belong to the corresponding UE group G_{K-1} (block 508-K−1: NO) selector 304 may select G_{K} and S_{K} as the UE group and the scheduling strategy for the UE 102 (block 510-K). As in the previous embodiment, after selecting S_{N}, selector 304 may provide S_{N} or the values of f and STP for the S_{N} to scheduler 306. In response, scheduler 306 may schedule data to/from UE 102 in accordance with the assigned values of f and STP to improve cell latency.

According to yet another embodiment, selector 304 may improve cell throughput. Similar to one of the previously described embodiments for improving low cell latency, selector 304 may be configured to estimate a cell load L that ranges from 0 to L_{MAX}. In addition, selector 304 may be configured to partition the range [0, L_{MAX}] into subranges [0, T₁], [T₁, T₂] . . . [T_{K-2}, T_{K-1}], and [T_{K-1}, T_{K}]. Furthermore, each of the subranges [T_{N-1}, T_{N}] (where N=1 . . . . K) is associated with a particular scheduling strategy S_{N} that specifies values for of frequency band f and STP. In effect, each S_{N} (N>0) may denote a partition in frequency, in time, or both in frequency and time. The partitions are such that given two subranges [Tᵢ₋₁, T₁] and [Tⱼ₋₁, Tⱼ], if i>j, then fᵢ<fⱼ. and STP; <STPⱼ. A particular band f may occupy a percentage of the cell band per unit time.

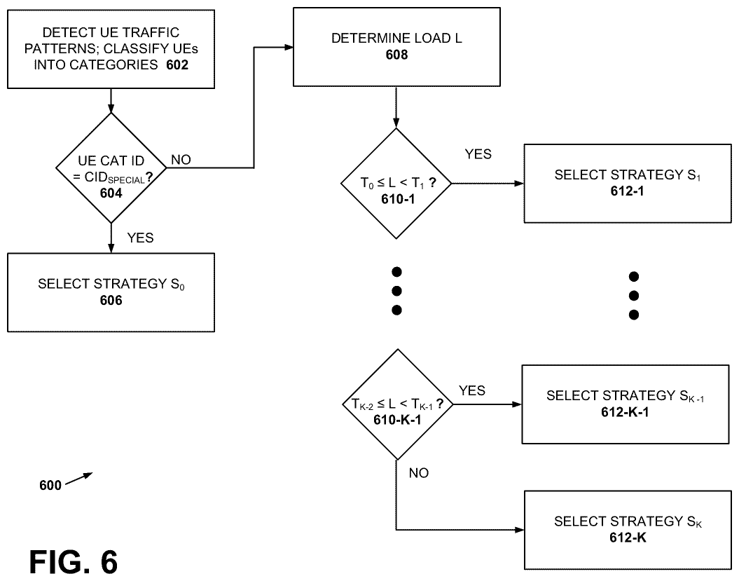

According to the embodiment, selector 304 may perform a process for selecting scheduling strategies S_{N} (N=0, 1 . . . or K) for the UEs 102 to improve cell throughput. FIG. 6 is a flow diagram of an example process 600 performed by selector 304 in access station 210 to increase cell throughput. As shown, process 600 may include selector 304 detecting UE traffic patterns for the cell and classifying the UEs 102 in the cell into various UE categories (block 602). When classifying the UEs 102, selector 304 may apply the definition of UE categories, provided by the 3GPP, or alternatively, provided by the mobile network operator or service provider. When classifying the UEs 102 into UE categories, selector 304 may consider a number of parameters. The parameters may include, for example, the detected traffic patterns and the network slice IDs, SINRs, RSRPs, CQIs, RIs, the price plan, QoS IDs, etc., that are associated with the UEs 102.

After classifying the UEs 102, selector 304 may determine, for each of the UEs 102, whether the UE 102 belongs to a UE category that requires special scheduling treatment (e.g., determine whether UE category ID=Category ID (CID) SPECIAL) (block 604). If the UE 102 belongs to a UE category that requires special scheduling treatment (e.g., UE category ID=CID_{SPECIAL}) (block 604: YES), selector 304 may select and assign scheduling strategy S₀ (a special strategy with large values of f and STP) for the UE 102 (block 606). On the other hand, if the UE 102 does not belong to a UE category that requires special scheduling treatment (e.g., UE category ID is not equal to CID_{SPECIAL}) (block 604: NO), selector 304 may determine the value of the cell load L (block 608). Selector 304 may determine the value of L based on the KPIs provided by interface 302. KPIs that selector 304 may use for determining load L may include, for example, the TTI utilization rate, the PRB utilization rate, the cell throughput, and the UE throughput.

Process 600 may further include selector 304 determining into which of the subranges [T_{N-1}, T_{N}] (N=1 . . . . K) L falls (blocks 610-1 through 610-K−1). If L falls in the subrange [T_{N-1}, T_{N}] (i.e., T_{N-1}≤L<T_{N}] (block 610-N: YES), selector 304 may select scheduling strategy S_{N} associated with the subrange (blocks 612-1 through 612-K−1). If L does not fall in subrange [T_{N-1}, T_{N}] (block 410-N: NO), selector 304 may proceed to block 610-N+1 to determine if L falls in the next subrange [T_{N-1}, T_{N}]. At block 610-K−1, if L does not fall in the corresponding subrange [T_{K-2}, T_{K-1}] (block 610-K−1: NO), L must fall in the last subrange (since there is only one more possible subrange) and accordingly, selector 304 may select S_{K} as the scheduling strategy (block 612-K).

After selecting S_{N}, selector 304 may provide S_{N} or the values of f and STP for the S_{N} to scheduler 306. In response, scheduler 306 may schedule data to/from UE 102 in accordance with the values of f and STP to increase cell throughput. If the value of L changes while UEs 102 are engaged in sessions, selector 304 may reassign new strategy S for each of the UEs 102 and provide the corresponding values of f and STP to scheduler 306. Because selector 304 may switch to a scheduling strategy whose values of f and STP are smaller when L increases, scheduler 306 may be able to accommodate more UEs 102 at acceptable cell throughput when the cell is heavily loaded or congested.

In some implementations, at blocks 612, rather than selecting a pre-assigned S_{N} (i.e., a particular combination of values for frequency band f and STP) for L in a particular range of values, selector 304 may select one of several possible strategies (e.g., S_{Ni}, where N, i>1) based on UE parameters, such as those discussed above (e.g., an RSRP, a CQI, a RI, a price plan, a UE category, a UE group, etc.), a QoS ID, a network slice ID, etc. In some implementations, the parameters may also include a made and model of UEs 102, the processor type, the amount of memory, the OS of the UE 102, etc.

Referring back to FIG. 3, scheduler 306 may schedule data for transmission to and reception from UE 102. In one implementation, scheduler 306 may be configured to receive as input, for each of the UEs 102, a selection of a scheduling strategy, a value of frequency band f from which scheduler 306 is to assign PRBs for scheduling, value of STP; or a combination of values for frequency band f and STP. Furthermore, scheduler 306 may be capable of scheduling data in accordance with the received S_{N} and/or the values of f and/or STP.

AMF 308 may perform registration management, connection management, reachability management, mobility management, lawful intercepts, Short Message Service (SMS) transport between UE 102 and a Short Message Service Function (SMSF), session management messages transport between UE 102 and a Session Management Function (SMF), access authentication and authorization, location services management, functionality to support non-3GPP access networks, and/or other types of management processes. AMF 308 may provide network traffic information pertaining to UEs 102 or network slices 212 to other network components, such as access station 210.

NWDAF 310 may collect analytics information associated with access network 204 and/or core network 206. For example, NWDAF 310 may obtain telemetry information relating to access network 204 from access stations 210 and provide collected telemetry information relating to UEs 102 to other network functions (NFs) and components. In another example, NWDAF 310 may obtain analytics information (e.g., predictive analytics data) for network slices 212 and provide them to a requesting network component. NWDAF 310 may also obtain KPIs (e.g., UE throughput, cell throughput, etc.) and provide them to other NFs and network components.

UDM 312 may maintain subscription information for UEs 102, manage subscriptions, generate authentication credentials, handle user identification, perform access authorization based on subscription data, perform network function registration management, maintain service and/or session continuity by maintaining assignment of an SMF for ongoing sessions, support SMS delivery, support lawful intercept functionality, and/or perform other processes associated with managing user data. UDM 312 may store the data that it manages in a Unified Data Repository (UDR). UDM 312 may provide 5QIs/QCIs associated with UE 102, network slice IDs associated with UE 102, a price plan of the subscribed service, and/or other information to other network components.

MME 314 may implement 4G control plane processing for core network 206. For example, MME 314 may manage the mobility of UE 102, implement tracking and paging procedures for UE 102, activate and deactivate bearers for UE 102, authenticate a user of UE 102, and/or interface to non-LTE radio access networks. A bearer may represent a logical channel with particular QoS requirements. MME 314 may also select a particular serving gateway (SGW) for a particular UE 102. MME 314 may play a similar role for 4G core network components as AMF 308 does for 5G core network components and may provide traffic-related information to other network components, such as access station 210.

HSS 316 may store subscription information associated with UEs 102 and/or information associated with users of UEs 102. For example, HSS 316 may store subscription profiles that include authentication, access, and/or authorization information. Each subscription profile may include information identifying UEs 102, authentication and/or authorization information for UEs 102, services enabled and/or authorized for UEs 102, device group membership information for UEs 102, and/or other types of information associated with UEs 102. HSS 316 may include user information and/or UE information that is consistent with the information stored at a UDR and/or managed by UDM 312.

FIG. 7 depicts exemplary components of a network device 700. Network device 700 may correspond to or be included in any of the devices and/or components illustrated in FIGS. 1A-1D, 2, and 3 (e.g., UE 102, network 104, access network 204, core network 206, data network 208, access station 210 and its components 302-306, core network components 308-316, etc.). In some implementations, network devices 700 may be part of a hardware network layer on top of which other network layers and NFs may be implemented. As shown, network device 700 may include a processor 702, memory/storage 704, input component 706, output component 708, network interface 710, and communication path 712. In different implementations, network device 700 may include additional, fewer, different, or different arrangement of components than the ones illustrated in FIG. 7. For example, network device 700 may include line cards, switch fabrics, modems, etc.

Processor 702 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 700 and/or executing programs/instructions.

Memory/storage 704 may include static memory, such as read only memory (ROM), and/or dynamic memory, such as random access memory (RAM), or onboard cache, for storing data and machine-readable instructions (e.g., programs, scripts, etc.). Memory/storage 704 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 704 may be external to and/or removable from network device 700. Memory/storage 704 may include, for example, a Universal Serial Bus (USB) memory stick, a dongle, a hard disk, off-line storage, a Blu-Ray® disk (BD), etc. Memory/storage 704 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 706 and output component 708 may provide input and output from/to a user to/from network device 700. Input/output components 706 and 708 may include a display screen, a keyboard, a mouse, a speaker, a microphone, a camera, a DVD reader, USB lines, and/or other types of components for obtaining, from physical events or phenomena, to and/or from signals that pertain to network device 700.

Network interface 710 may include a transceiver (e.g., a transmitter and a receiver) for network device 710 to communicate with other devices and/or systems. For example, via network interface 710, network device 700 may communicate over a network, such as the Internet, an intranet, cellular, a terrestrial wireless network (e.g., a WLAN, WIFI, WIMAX, etc.), a satellite-based network, optical network, etc. Network interface 710 may include a modem, an Ethernet interface to a LAN, and/or an interface/connection for connecting network device 700 to other devices (e.g., a Bluetooth interface). Communication path or bus 712 may provide an interface through which components of network device 700 can communicate with one another.

Network device 700 may perform the operations described herein in response to processor 702 executing software instructions stored in a non-transient computer-readable medium, such as memory/storage 704. The software instructions may be read into memory/storage 704 from another computer-readable medium or from another device via network interface 710. The software instructions stored in memory/storage 704, when executed by processor 702, may cause processor 702 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions have been described with reference to FIGS. 4-6. the order of the actions may be modified in other implementations. In addition, non-dependent actions may be performed in parallel and in different orders. Furthermore, each of the actions may include one or more constituent actions.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code-it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
receive, from one or more network components, key performance indicators (KPIs) and parameters that are associated with a User Equipment device (UE);
select, based on the KPIs and the parameters, a scheduling strategy for data communications over a wireless link between the device and the UE;
apply the selected scheduling strategy to schedule data for transmission to the UE; and
transmit the data to the UE based on the scheduling.

2. The device of claim 1, wherein the scheduling strategy includes values, for a frequency band f and a scheduling transmission period, to be used by the UE and the device for communications.

3. The device of claim 1, wherein the parameters include:
a price plan to which the UE is subscribed;
a Fifth Generation Quality-of-Service Identifier (5QI);
a Quality-of-Service Class Identifier (QCI);
a Single-Network Slice Selection Assistance Information (S-NSSAI);
a make and model of the UE;
a Reference Signal Received Power (RSRP) associated with the UE;
a Signal to Interference Plus Noise Ratio (SINR) associated with the UE;
a Channel Quality Information (CQI) associated with the UE;
an operating system installed on the UE;
identifiers (Ds) for applications installed on the UE;
network operator-defined UE categories; or
standard UE categories.

4. The device of claim 1, wherein the KPIs include one or more of:
a throughput of a cell associated with the device;
a throughput of UEs in the cell;
a physical resource block (PRB) utilization rate; or
a transmission time interval (TTI) utilization rate.

5. The device of claim 1, wherein when the processor selects the scheduling strategy, the processor is configured to:
determine a cell load based on the KPIs; and
select the scheduling strategy based on the determined cell load.

6. The device of claim 1, wherein when the processor selects the scheduling strategy, the processor is configured to:
identify a UE group to which the UE belongs based on the parameters; and
select the scheduling strategy based on the identified UE group.

7. The device of claim 1, wherein when the processor selects the scheduling strategy, the processor is configured to:
identify a UE category to which the UE belongs based a traffic pattern of the UE and on an identifier for a network slice to which the UE is subscribed.

8. The device of claim 1, wherein the one or more network components include one or more of:
a Network Data Analytics Function (NWDAF);
an Access and Mobility Management Function (AMF);
a Unified Data Management (UDM);
a Mobility Management Entity (MME); or
a Home Subscriber Server.

9. A method comprising:
receiving, by a device from one or more network components, key performance indicators (KPIs) and parameters that are associated with a User Equipment device (UE);
selecting, based on the KPIs and the parameters, a scheduling strategy, for data communications over a wireless link between the device and the UE;
applying the selected scheduling strategy to schedule data for transmission to the UE; and
transmitting the data to the UE based on the scheduling.

10. The method of claim 9, wherein the scheduling strategy includes values, for a frequency band f and a scheduling transmission period, to be used by the UE and the device for communications.

11. The method of claim 9, wherein the parameters include:
a price plan to which the UE is subscribed;
a Fifth Generation Quality-of-Service Identifier (5QI);
a Quality-of-Service Class Identifier (QCI);
a Single-Network Slice Selection Assistance Information (S-NSSAI);
a make and model of the UE;
a Reference Signal Received Power (RSRP) associated with the UE;
a Signal to Interference Plus Noise Ratio (SINR) associated with the UE;
a Channel Quality Information (CQI) associated with the UE;
an operating system installed on the UE;
identifiers (Ds) for applications installed on the UE;
network operator-defined UE categories; or
standard UE categories.

12. The method of claim 9, wherein the KPIs include one or more of:
a throughput of a cell associated with the device;
a throughput of UEs in the cell;
a physical resource block (PRB) utilization rate; or
a transmission time interval (TTI) utilization rate;

13. The method of claim 9, wherein when selecting the scheduling strategy includes:
determining a cell load based on the KPIs; and
selecting the scheduling strategy based on the determined cell load.

14. The method of claim 9, wherein selecting the scheduling strategy includes:
identifying a UE group to which the UE belongs based on the parameters; and
selecting the scheduling strategy based on the identified UE group.

15. The method of claim 9, wherein selecting the scheduling strategy includes:
identifying a UE category to which the UE belongs based a traffic pattern of the UE and on an identifier for a network slice to which the UE is subscribed.

16. The method of claim 9, wherein the one or more network components include one or more of:
a Network Data Analytics Function (NWDAF);
an Access and Mobility Management Function (AMF);
a Unified Data Management (UDM);
a Mobility Management Entity (MME); or
a Home Subscriber Server.

17. A non-transitory computer-readable storage medium comprising processor-executable instructions, which when executed by one or more processors of a device, cause the one or more processors to:
receive, from one or more network components, key performance indicators (KPIs) and parameters that are associated with a User Equipment device (UE);
select, based on the KPIs and the parameters, a scheduling strategy, for data communications over a wireless link between the device and the UE;
apply the selected scheduling strategy to schedule data for transmission to the UE; and
transmit the data to the UE based on the scheduling.

18. The non-transitory computer-readable storage medium of claim 17, wherein the scheduling strategy includes values for a frequency band f and a scheduling transmission period, to be used by the UE and the device for communications.

19. The non-transitory computer-readable storage medium of claim 17, wherein the parameters include:
a price plan to which the UE is subscribed;
a Fifth Generation Quality-of-Service Identifier (5QI);
a Quality-of-Service Class Identifier (QCI);
a Single-Network Slice Selection Assistance Information (S-NSSAI);
a make and model of the UE;
a Reference Signal Received Power (RSRP) associated with the UE;
a Signal to Interference Plus Noise Ratio (SINR) associated with the UE;
a Channel Quality Information (CQI) associated with the UE;
an operating system installed on the UE;
identifiers (Ds) for applications installed on the UE;
network operator-defined UE categories: or
standard UE categories.

20. The non-transitory computer-readable storage medium of claim 17, wherein the scheduling strategy includes values for a frequency band/and a scheduling transmission period, to be used by the UE and the device for communications.
